(19) United States
(12) Patent Application Publication
(10) Pub. No.: US 2010/0011388 A1
(43) Pub. Date: Jan. 14, 2010

(54) System and method for creating playlists based on mood

(76) Inventors: William Bull, Mountain View, CA (US); Policarpo Wood, Cupertino, CA (US); Kourtny Hicks, Sunnyvale, CA (US); Benjamin Andrew Rottler, Burlingame, CA (US); Eric Hope, Cupertino, CA (US); Alan Cannistraro, San Francisco, CA (US)

Correspondence Address: KRAMER LEVIN NAFTALIS & FRANKEL LLP, 1177 Avenue of the Americas, New York, NY, 10036, US

(21) Appl. No.: 12/218,203

(22) Filed: Jul. 10, 2008

(51) Int. Cl. H04N 7/16

(52) U.S. Cl. 725/9

(57) ABSTRACT

Suggested media playlists are created by an electronic device based upon the mood of a user as analyzed by the electronic device. The electronic device may suggest media items for playback based upon the user's past preferences for certain media items during previously similar moods.

### FIELD OF THE INVENTION

This invention relates to systems and methods for suggesting media to be provided using an electronic device based upon the current mood of a user and based upon a user's prior media selections.

### BACKGROUND OF THE DISCLOSURE

Many electronic devices play a variety of media items such as sound and audio items, videos, movies, or photographs. A user of an electronic device may select for playback a particular media item based upon any suitable condition, such as the user's current mood. For example, a user may select a piece of music with a slow tempo and a quiet volume if the user is feeling angry and would like to feel calm. Alternatively, a user may select a comedic movie to view if the user is feeling happy. However, the electronic device can not independently ascertain the user's mood and suggest various media items that the user might prefer based upon the user's current mood.

Therefore, it would be beneficial to provide systems and methods for determining the mood of a user of an electronic device and for suggesting media to be played back based upon the user's mood. In addition, it also would be beneficial to provide systems and methods for suggesting media based upon similar moods previously experienced by the user and the user's media selections with respect to those previous moods.

### SUMMARY OF THE DISCLOSURE

Systems and methods for presenting suggested media on an electronic device in response to determining the mood of a user are provided. In some embodiments, an electronic device is provided for suggesting media for playback based on a user's mood, the electronic device comprising control circuitry and a display. The control circuitry is operative to detect a capacitance value from the user, determine the user's mood using the detected capacitance value, identify at least one media item available for playback associated with the detected user's mood, and direct the display to present the at least one identified media item to the user.

In some embodiments, the electronic device may suggest media for playback based upon a user's past mood. The control circuitry is operative to detect a capacitance value from the user, determine the user's mood using the detected capacitance value, compare the user's current mood to information stored in the control circuitry related to the user's past moods, identify at least one past media item selection based upon the information stored in the control circuitry, identify at least one current media item available for playback using the user's past moods, and direct the display to present the at least one current media item to the user.

In some embodiments, a method is provided for suggesting a media playlist for playback on an electronic device based upon a user's mood. The method comprises detecting a capacitance value from the user, determining the user's mood using the detected capacitance value, identifying at least one media item available for playback using the user's mood, assembling the media playlist from the at least one identified media item, and playing back the at least one identified media item from the media playlist.

In some embodiments, a system is provided for suggesting a media playlist for playback based upon a user's mood. The system comprises an electronic device, control circuitry within the electronic device for detecting a capacitance value from the user, determining the user's mood, identifying at least one media item available for playback, and assembling the media playlist from the at least one identified media item, and a display within the electronic device for presenting the media playlist.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1 is a schematic view of an electronic device in accordance with some embodiments of the invention;

FIG. 2 is a schematic view of an illustrative display for obtaining capacitance values in accordance with some embodiments of the invention;

FIG. 3 is a schematic view of an illustrative display screen for assembling suggested media based upon a user's mood in accordance with some embodiments of the invention;

FIG. 4 is a schematic view of an illustrative display screen for viewing suggested media types based upon a user's mood in accordance with some embodiments of the invention;

FIG. 5 is a schematic view of an illustrative display screen for selecting suggested media items having associated media moods in accordance with some embodiments of the invention;

FIG. 6 is a schematic view of an illustrative display screen for viewing suggested media types with associated media moods based upon a user's past media selections in accordance with some embodiments of the invention;

FIG. 7 is a schematic view of an illustrative data structure for storing information related to media types and media moods associated with a particular user mood in accordance with some embodiments of the invention;

FIG. 8 is a schematic view of an illustrative data structure for storing information related to a user's media selections associated with a particular mood in accordance with some embodiments of the invention;

FIG. 9 is a schematic view of an illustrative data structure for storing information reflecting a user's prior media selections associated with a particular mood in accordance with some embodiments of the invention;

FIG. 10 is a flowchart of an illustrative process for playing a selected media item suggested by an electronic device based upon a user's mood in accordance with some embodiments of the invention; and

FIG. 11 is a flowchart of an illustrative process for updating media suggestions media based upon a user's prior media selections in accordance with some embodiments of the invention.

### DETAILED DESCRIPTION OF THE DISCLOSURE

In some embodiments of the invention, an electronic device may determine the current mood of a user and may suggest media for playback based upon the user's mood. The electronic device may include any device capable of transmitting, receiving, and playing back any suitable type of media. The media types that the electronic device may suggest may include any suitable type of media, such as sound or audio files, videos, photographs, movies, websites, magazines, books, or any other suitable type.

The electronic device may determine the user's current mood using any suitable approach. In some embodiments of the invention, the electronic device may include any suitable sensor, such as a capacitance sensor, located within the circuitry of the electronic device. In some embodiments of the invention, the capacitance sensor may be located within another device that may be peripheral to the electronic device. The capacitance sensor may obtain a capacitance value from the user using any suitable method. For example, the user may touch the display of the electronic device, and the capacitance sensor may obtain a capacitance value from that touch. The capacitance sensor may transmit the capacitance value to the circuitry, and the circuitry may analyze the capacitance value by comparing it to other capacitance values obtained from the user and stored in the memory of the electronic device. In one embodiment, the circuitry may compare the capacitance value to a pre-programmed set of capacitance values corresponding to a common set of moods for a sample of individuals. The electronic device may determine the mood of the user as a result of the analysis of the capacitance value obtained from the user.

In some embodiments, the electronic device may always be enabled to determine the user's mood while in some embodiments, the user may enable or disable the application that may determine the user's mood and may suggest media based on that mood. The application may be enabled or disabled using any suitable means, such as by a touch on a display screen, a verbal command or key command (e.g., a keystroke), a mechanical switch, or any other suitable means.

After determining the current mood of the user, the electronic device may assemble suggested media items for playback using any suitable approach. In some embodiments, the electronic device may suggest numerous media types (e.g., music, videos, movies) and numerous media items within each type. The electronic device may suggest media types with associated media moods that match the user's current mood, or the electronic device may suggest media types with associated media moods that differ from or are opposite to the user's current mood. In some embodiments, the electronic device may suggest only one media type and/or only one or a small number of media items. In some embodiments, the electronic device may obtain the media items within each suggested media type by downloading the media items from an external source. Those media items that may be streamed to the electronic device may not be stored in the memory of the electronic device, and different media items may be streamed to the electronic device in the future, even if the user's mood remains the same. The suggested media may be formatted in any suitable manner. For example, the playlist may be organized by popularity of a particular media type, alphabetically by title of media type, chronologically by date of storage in the electronic device, or by any other suitable means.

In some embodiments, the electronic device may suggest media based upon a user's prior mood, if the prior mood is similar to the user's current mood. The electronic device may store in its memory information related to the user's prior media selections when the user was experiencing the same mood in the past. The memory may be consulted to assemble media suggestions that are the result of the electronic device learning from the user's prior selections. The suggested media may vary in the media types offered to a user while maintaining the media mood that the user selected during a previously similar mood. Alternatively, the electronic device may suggest media that varies the media moods offered by the media types, even if the media types offered to a user have not changed between the previously similar mood and the current mood.

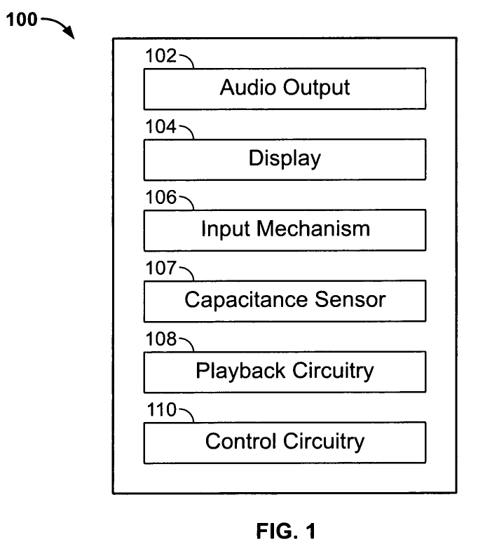

Systems and methods for presenting on an electronic device media suggestions based upon the mood of a user are provided and described with reference to FIGS. 1-11.

FIG. 1 is a schematic view of an electronic device in accordance with some embodiments of the invention. The electronic device may include any suitable device for transmitting and receiving inputs, and for obtaining a capacitance value from a user. For example, electronic device may include a desktop computer, a laptop computer, a device capable of communicating wirelessly (with or without the aid of a wireless enabling accessory system) or via wired pathways (e.g., using traditional electrical wires), a pocket-sized personal computer such as an iPAQ Pocket PC available by Hewlett Packard Inc. of Palo Alto, Calif., a personal digital assistant (“PDA”), a personal e-mail or messaging device with audio and/or video capabilities (e.g., a Blackberry® or a Sidekick®), or an iPod™ touch or an iPhone available by Apple Inc. of Cupertino, Calif. The input may include any suitable form of instruction, including for example, voice instruction, data instruction, manual instruction (e.g., a keystroke), an instruction from a program installed in the electronic device, an instruction based upon a sensed condition (e.g., an input related to a capacitance value obtained by the electronic device), or combinations thereof.

Electronic device 100 may include audio output 102, display 104, input mechanism 106, capacitance sensor 107, playback circuitry 108, control circuitry 110, and any other suitable components. All of the applications employed by audio output 102, display 104, input mechanism 106, capacitance sensor 107, and playback circuitry 108 may be interconnected and managed by control circuitry 110.

Audio output 102 may include any suitable audio component for providing audio to the user of electronic device 100. For example, audio output 102 may include one or more speakers (e.g., mono or stereo speakers) built into electronic device 100. In some embodiments, audio output 102 may include an audio component that is remotely coupled to electronic device 100. For example, audio output 102 may include a headset, headphones or earbuds that may be coupled to electronic device 100 with a wire (e.g., coupled to electronic device 100 with a jack) or wirelessly (e.g., Bluetooth® headphones or a Bluetooth® headset).

Display 104 may include any suitable screen or projection system for providing a display visible to the user. For example, display 104 may include a screen (e.g., an LCD screen) that is incorporated in electronic device 100. As another example, display 104 may include a movable display or a projecting system for providing a display of content on a surface remote from electronic device 100 (e.g., a video projector). Display 104 may be operative to display content (e.g., information regarding suggested media that may be played to correspond with a user's mood) under the direction of control circuitry 110.

Input mechanism 106 may be any suitable mechanism for providing user inputs or instructions to electronic device 100. Input mechanism 106 may take a variety of forms, such as a touch screen, a button, keypad, dial, or a click wheel. The user interface may include a multi-touch screen such as that described in U.S. Pat. No. 6,323,846, which is incorporated by reference herein in its entirety. The user interface may emulate a rotary phone or a multi-button keypad, which may be implemented on a touch screen or the combination of a click wheel or other user input device and a screen. A more detailed discussion of such a rotary phone interface may be found, for example, in U.S. Patent Publication No. 20070152983, published Jul. 5, 2007, entitled “Touch Pad with Symbols based on Mode,” which is incorporated by reference herein in its entirety.

Capacitance sensor 107 may be any suitable sensor operative to obtain a capacitance value from a user of electronic device 100. Capacitance sensor 107 may be integrated in any useful location within electronic device 100. For example, capacitance sensor 107 may be integrated with display 104. Alternatively, capacitance sensor 107 may be integrated with an input mechanism (e.g., a button on a pair of headphones), where the user may naturally place a finger. Alternatively, capacitance sensor 107 may be integrated with control circuitry 110. In some embodiments, capacitance sensor 107 may be included within an accessory device that may be coupled (via a wired pathway or wirelessly) to electronic device 100. For example, capacitance sensor 107 may transmit a detected capacitance value to control circuitry 110 when a user touches display 104. Alternatively, capacitance sensor 107 may transmit a detected capacitance value to any other suitable portion of electronic device 100 to which capacitance sensor 107 is connected (e.g. a button or portion of the housing). In some embodiments, electronic device 100 may include one or more applications operative to calculate and analyze a capacitance value obtained by capacitance sensor 107 from a user of electronic device 100. In some embodiments, electronic device 100 may include any other type of suitable sensor to sense the user's mood and to signal control circuitry 110 to suggest one or more media items.

Playback circuitry 108 may be any suitable circuitry operative to read, classify, store, play and transmit different types of media to an active output such as audio output 102 (e.g., audio) or display 104 (e.g., video) at the direction of control circuitry 110. Playback circuitry 108 may be operative to interface with control circuitry 110 to play any suitable media item, or any suitable number of media items simultaneously, suggested by electronic device 100 and selected by a user based upon the user's mood. In some embodiments, playback circuitry 108 may be incorporated in control circuitry 110.

Control circuitry 110 may be operative to control the operations and performance of electronic device 100. Control circuitry 110 may include, for example, a processor, a bus (e.g., for sending instructions to the other components of electronic device 100), memory, storage, or any other suitable component for controlling the operations of electronic device 100. In some embodiments, a processor may drive the display and process inputs received from the user interface (e.g., the touch screen). The memory and storage may include, for example, cache, Flash, ROM, and/or RAM. In some embodiments, memory may be specifically dedicated to storing firmware (e.g., for device applications such as an operating system, user interface functions, and processor functions). In some embodiments, memory may be operative to store a media item that electronic device 100 may download from a host system. Alternatively, control circuitry 110 may stream the media item from a source to make the media item available for playback without storing the media item in the memory.

Control circuitry 110 may be operative to perform the operations of one or more applications implemented on electronic device 100. Any suitable number or type of applications may be implemented. Although the following discussion will enumerate different applications, it will be understood that some or all of the applications may be combined into one or more applications. In some embodiments, electronic device 100 may include one or several applications operative to download and play a variety of media items (e.g., songs, videos, movies, photographs), one at a time or two or more media items simultaneously, that may have been stored in electronic device 100 or that may be streamed to electronic device 100 (e.g., using communications circuitry).

Control circuitry 110 may include additional circuitry (e.g., logic circuitry) that may analyze the received capacitance value by comparing it with stored capacitance values obtained from the user over time to calculate a baseline capacitance that control circuitry 110 may store in memory and use in analyzing capacitance fluctuations to determine the user's mood. Alternatively, the logic circuitry within control circuitry 110 may analyze the received capacitance value by comparing it with a pre-determined range of capacitance values that may have been programmed into electronic device 100 (e.g., where the pre-determined ranges of capacitance values may correspond to a common mood of a sample of individuals). If the logic circuitry matches the received capacitance value to a pre-determined range of capacitance values to determine the user's mood, control circuitry 110 may signal one or more applications in electronic device 100 to suggest media associated with the analyzed capacitance value.

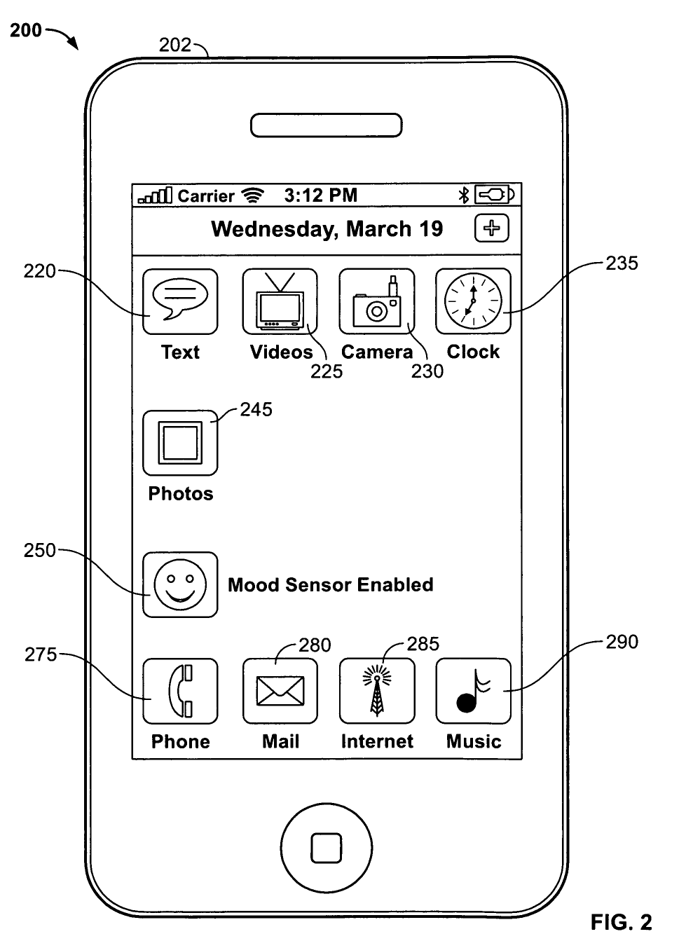

An electronic device may suggest media to a user for playback based upon the user's mood using any suitable approach. FIGS. 2-6 are schematic views of illustrative display screens that may be displayed as an electronic device determines a user's mood and suggests media for playback based upon the user's mood. The electronic device of each of FIGS. 2-6 may be the same as or different from, and may include some or all of the features of, electronic device 100 (FIG. 1). The user's mood may be determined using any suitable approach, such as by evaluating capacitance changes in the user over time. Capacitance sensor 107 may measure capacitance values of the user for analysis by control circuitry 110 to determine the user's mood. The user may provide inputs to the electronic device using any suitable input mechanism, including for example an interface that includes a touch screen, a “home” button, a click-wheel, combinations thereof, or any other suitable input mechanism.

FIG. 2 is a schematic view of an illustrative display for obtaining capacitance values in accordance with some embodiments of the invention. Display screen 200, which may be the same as, and may include some or all of the features of, display 104 (FIG. 1), may be displayed when electronic device 202 is turned on (e.g., display screen 200 may represent the “home” screen of electronic device 202). In some embodiments, display screen 200 may include several selectable options for operating different applications of electronic device 202. Options may include, for example, Text option 220, Videos option 225, Camera option 230, Clock option 235, Photos option 245, Mood option 250, Phone option 275, Mail option 280, Internet option 285, Music option 290, or any other suitable option. One or more of the options, such as Phone option 275, may appear on display screen 200 regardless of the application being run by electronic device 202.

A user of electronic device 202 may select Text option 220 to transmit text messages to or receive text messages from another electronic device. Videos option 225 may be selected to display and organize video media stored within electronic device 202 or capable of being streamed to electronic device 202 for viewing. Camera option 230 may allow the user to take photographs with electronic device 202. Clock option 235 may allow the user to alter the settings of electronic device 202 to correspond with a particular time zone, to set an alarm application as a reminder, or to perform any other suitable time-based function using electronic device 202. Photos option 245 may allow the user to display and organize photographs captured by Camera option 230 or any other photographs stored in or streamed to electronic device 202. Phone option 275 may allow a user to place and receive telephone calls, listen to voicemails, and review received telephone calls using electronic device 202. Mail option 280 may allow a user to send, receive, organize and review emails in one or more email accounts accessible by electronic device 202. Internet option 285 may allow a user to access and navigate the Internet using electronic device 202. Music option 290 may allow a user to listen to, download, organize and store music media items on electronic device 202.

In some embodiments, Mood option 250 may be selected to allow electronic device 202 to determine the user's mood when the user touches display screen 200. For example, the user may use display screen 200 to select a displayed option. A capacitance value may be obtained from the user using capacitance sensor 107 (FIG. 1) even if the user is not using electronic device 202 with the primary intention of selecting a media item based upon mood. The capacitance value obtained by capacitance sensor 107 may be analyzed by control circuitry 110 and may be used to suggest media to the user that the user may wish to play back based on the user's detected mood.

In some embodiments, the user may not wish that the mood application be always enabled. For example, the user may not wish to view suggested video items while in a movie theater, or the user may not wish to listen to suggested music items while using a particular application (e.g., while using the phone application). The user may enable or disable the mood application, represented by Mood option 250, using any suitable approach. For example, touching the Mood option 250 icon may cause a dialogue box (not shown) to appear on display screen 200. The dialogue box may contain any suitable message, such as “Enable/Disable Mood Option?” to permit the user to select the dialogue box and to confirm the user's choice to disable Mood option 250. In some embodiments, Mood option 250 may always be enabled on electronic device 202. In some embodiments, Mood option 250 may not appear on display screen 200, but may be enabled by an input or an input mechanism, such as a switch or a button, on the housing of electronic device 202. In some embodiments, Mood option 250 may be enabled within electronic device 202 by a voice command or other command (e.g., a pre-programmed keystroke or entry of a PIN) from the user.

If the user enables Mood option 250, electronic device 202 may obtain a capacitance value when the user touches display screen 200. Control circuitry 110 (FIG. 1) may obtain the capacitance value from capacitance sensor 107. Control circuitry 110 may include a memory which may store previous capacitance values obtained when the user touched display screen 200 in the past. Control circuitry 110 may also include additional circuitry (e.g., logic circuitry) which may average the stored capacitance values obtained from the user over time, to calculate a baseline capacitance that control circuitry 110 may store in the memory and may use in analyzing capacitance fluctuations to determine changes in the user's mood.

In some embodiments, control circuitry 110 may compare the most recent capacitance value obtained from the user against the stored baseline capacitance to determine the user's mood. Control circuitry 110 may have stored in its memory a range of capacitance values that may be associated with common moods observed in a sample of individuals. Each range of capacitance values may correspond to a particular mood. Control circuitry 110 may compare the most recent capacitance value obtained from the user against the range of representative capacitance values and if the recent capacitance value falls within a range, control circuitry 110 may use that comparison to determine the user's mood.

In some embodiments, control circuitry 110 may use capacitance sensor 107 coupled to a pressure sensor to determine the user's mood. For example, a pressure sensor may obtain a pressure reading when the user touches display screen 200 and may transmit to control circuitry 110 a signal indicating that the user is pressing harder than average on display screen 200. Depending on the capacitance value recorded by capacitance sensor 107, control circuitry 110 may switch between one of the two obtained values, or may use the two obtained values in conjunction, to determine that the user's mood may be anxious or angry. In some embodiments, control circuitry 110 may include any suitable number of switchable sensors or combination of sensors to detect and/or measure a capacitance value of the user.

In some embodiments, control circuitry 110 may use a capacitance value obtained from the user to automatically begin playback of certain media suggestions without presenting a further display screen to the user. For example, the user may use display screen 200 for any reason, control circuitry 110 may calculate a capacitance value and determine the user's mood, and automatically begin to play selected media items (e.g., songs). The user may view and/or listen to the media, or may halt the automatic play back of the selected media items using any suitable method.

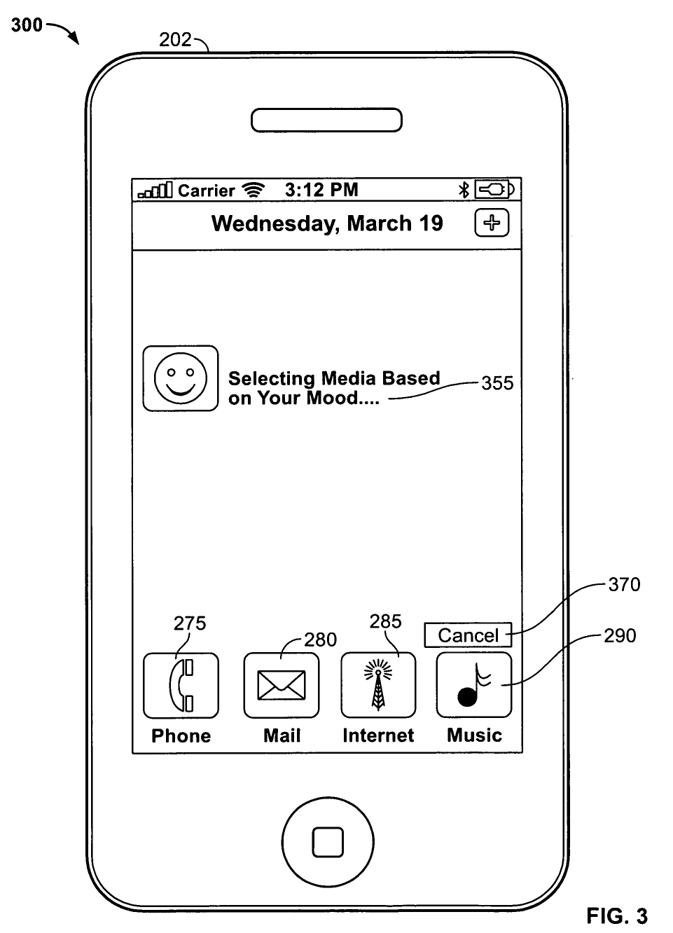

FIG. 3 is a schematic view of an illustrative display screen for assembling suggested media based upon a user's mood in accordance with some embodiments of the invention. Display screen 300, which may be the same as and may include some or all of the features of display screen 200, may be displayed once the user has touched display screen 200 (FIG. 2). In some embodiments, display screen 300 also may include Phone option 275, Mail option 280, Internet option 285, Music option 290, or any other suitable option. For example, all of the options shown on display screen 200 may still be visible on display screen 300, even if the user has already touched display screen 200 and control circuitry 110 may be in the process of determining the user's mood.

Display screen 300 may provide any suitable indication to the user that electronic device 202 is assembling media suggestions corresponding to the user's mood while control circuitry 110 determines the user's mood. For example, display screen 300 may present a message such as message 355, “Selecting Media Based on Your Mood . . . ” In some embodiments, display screen 300 may not present a message to the user but may assemble media suggestions in the background while the user interacts with one or more other options shown on display screen 200 or display screen 300.

Electronic device 202 may assemble media suggestions based upon the user's mood using any suitable approach. In some embodiments, media items stored within the memory of control circuitry 110 may be associated with metadata. The metadata may accompany each media item and may include a media mood associated with each media item (e.g., a song is associated with a “happy” metadata tag). For example, the company that publicly distributes the media item may include metadata classifying the media mood for electronic device 202. Alternatively, a user of electronic device 202 may insert or modify mood metadata associated with the media item when storing the media item in the memory of control circuitry 110. In some embodiments, electronic device 202 may communicate with a host system and request that metadata, including the media mood associated with a media item, be sent to or updated within electronic device 202 by the host system. In some embodiments, control circuitry 110 may ascertain the media mood associated with a media item by analyzing other metadata associated with the media item. For example, the metadata may include information related to the media item such as the title, the author or composer, the source from which the media item was obtained, the year the media item was created, the lyrics or text of the media item, or any other suitable information. Control circuitry 110 may use the metadata unique to the media item to determine the media mood associated with the media item.

Electronic device 202 may accumulate media suggestions using any suitable source. In some embodiments, electronic device 202 may assemble media suggestions, using the user's mood as a guide, from the media items stored in the memory of control circuitry 110. In some embodiments, control circuitry 110 may communicate with a host system and request that media content corresponding to the user's current mood, as determined by electronic device 202, be sent to electronic device 202 by the host system. The host system may stream one or more media items, for example selected to match or to oppose the detected mood of the user, to electronic device 202 or to a particular application within electronic device 202. The media items streamed to electronic device 202 by the host system also may vary such that electronic device 202 may present new media choices to the user for a given mood that differ from media choices that were previously provided during a similar past mood. The user may have the option of storing in electronic device 202 any streamed media item sent from the host system.

The user may interrupt the assembly of media suggestions by electronic device 202 using any suitable approach. For example, display screen 300 may include a selectable option to cancel the assembly process, such as Cancel option 370. Electronic device 202 may halt the analysis of the user's mood and the assembly of media suggestions and the user may be returned to another screen on electronic device 202 (e.g., display screen 200).

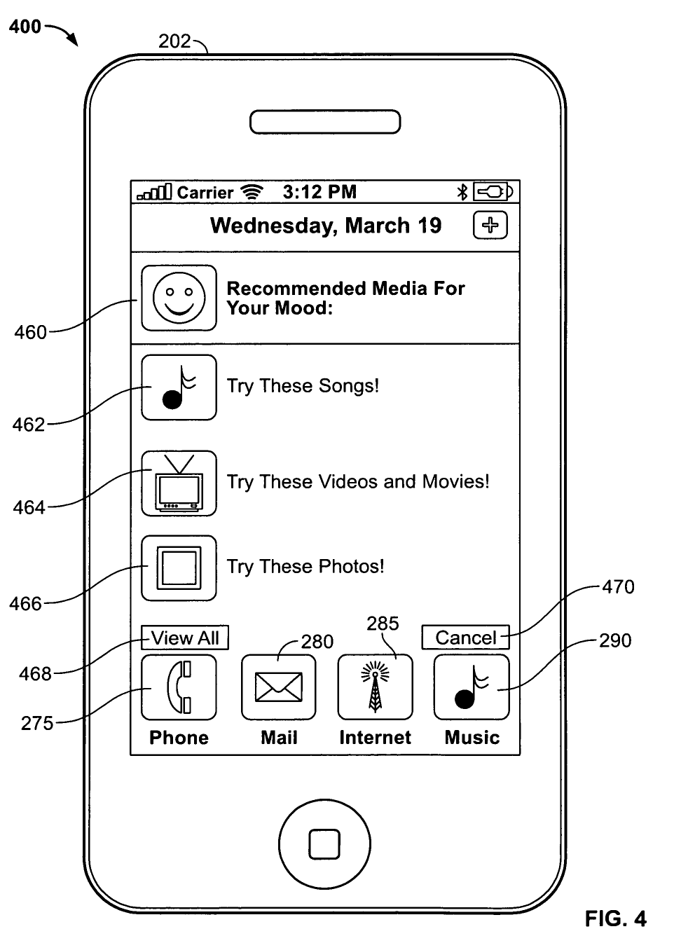

Electronic device 202 may present an assembly of media suggestions using any suitable approach. FIG. 4 is a schematic view of an illustrative display screen for viewing suggested media types based upon a user's mood in accordance with some embodiments of the invention. Display screen 400, which may be the same as and may include some or all of the features of display screen 200, may be displayed after electronic device 202 has assembled the media suggestions based upon the user's mood. Display screen 400 may present a message to the user indicating that electronic device 202 has assembled media suggestions, such as message 460 “Recommended Media for your Mood.”

Electronic device 202 may organize the presentation of the suggested media using any suitable approach. For example, display screen 400 may present an icon for each media type suggested by electronic device 202 based upon the user's mood. Such icons may include, for example, Suggested Music icon 462, Suggested Videos icon 464, and Suggested Photos icon 466. A user may select Suggested Music icon 462 to review playlists of songs, sorted by music mood, or playlists of other audio media suggested by electronic device 202 based upon the user's mood. Display screen 400 may also present a message or other information to the user, such as the message “Try these songs!” to encourage the user to review the suggested music assembled by electronic device 202. It is to be understood that these icon examples are representative of the media types that electronic device 202 may present to a user, and that the present invention enables electronic device 202 to present any suitable media, information, or data to a user based upon the user's mood via display screen 400. For example, display screen 400 may display a list of links to the user's favorite websites, or titles of suggested written works (e.g., poetry, novels, magazines, or plays) that the user may wish to access based upon the user's current mood.

In some embodiments, display screen 400 may not include icons for each suggested media type. For example, display screen 400 may present one playlist of all of the suggested media items organized in any suitable manner (e.g., alphabetically by title of media item, categorically by associated media mood, or chronologically by date that the media item was stored in electronic device 202) without requiring the user to first choose a media type. In some embodiments, display screen 400 may present icons for each suggested media type in any suitable manner, such as in a horizontal fashion across the top of display screen 400 rather than vertically along the left side of display screen 400. In some embodiments, if electronic device 202 determines that the user's mood is the same as a mood previously analyzed by electronic device 202, display screen 400 may present only that media type or types that the user may have selected during the previously similar mood.

In some embodiments, the user may wish to preview all of the suggested media items before selecting a particular media type. Display screen 400 may present any suitable icon, such as View All icon 468, to allow a user to preview all of the suggested media items assembled by electronic device 202 without first choosing a media type. The user may interrupt the review of the media types or the preview of all of the media items using any suitable approach, such as by touching Cancel option 570, which may return the user to another screen on electronic device 202 not related to the suggested media (e.g., display screen 200).

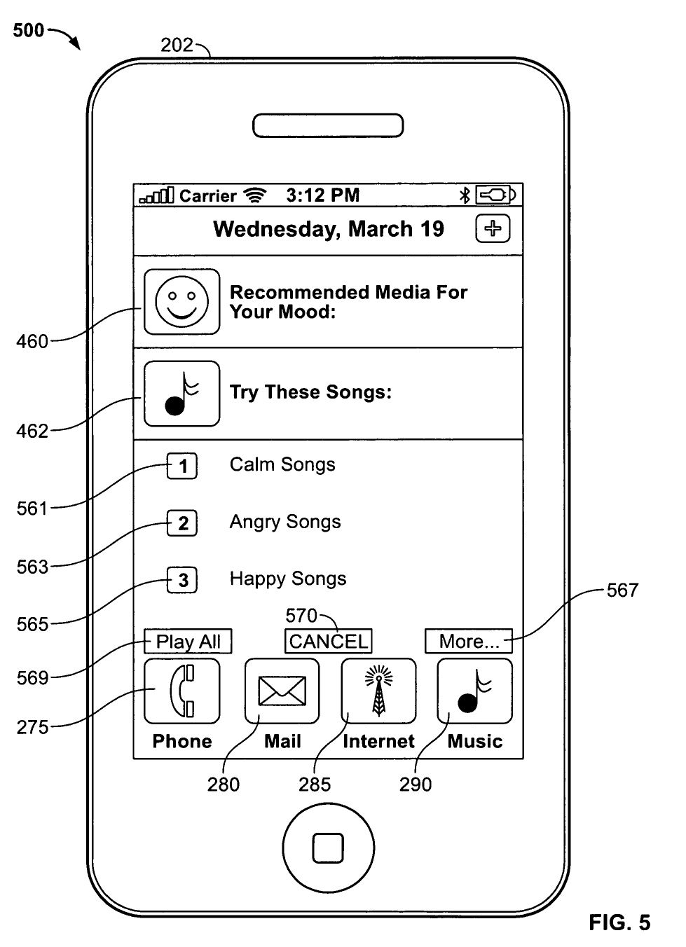

If a user selects one of the icons representing a suggested media type, such as Suggested Music icon 462, the user may be taken to a subsequent display screen to review and further select suggested media items within that selected media type. FIG. 5 is a schematic view of an illustrative display screen for selecting suggested media items having associated media moods in accordance with some embodiments of the invention. Display screen 500, which may be the same as and may include some or all of the features of display screen 200, may be displayed once a user has selected one of the media types suggested on display screen 400. Display screen 500 may retain message 460 and Suggested Music icon 462 (FIG. 4) from display screen 400 to indicate the user's navigation path to display screen 500. The user may touch Cancel option 570 to be returned to display screen 400 to select a different media type, such as videos or photos.

Electronic device 202 may organize the presentation of each suggested media item using any suitable approach. For example, display screen 500 may present any suitable icons, such as icons 561, 563, and 565, to present to the user media items within the media type selected from display screen 400 that may be further categorized by their associated media moods (e.g., calm songs, angry songs, or happy songs). For example, calm songs may be accessed by selecting icon 561. The user may touch any of icons 561, 563, or 565 to direct electronic device 202 to present a display screen (not shown) with a list of media items within the selected media type that also are associated with the selected media mood. Alternatively, the user may touch any of icons 561, 563, or 565 to direct playback circuitry 108 (FIG. 1) to play each media item assembled by electronic device 202 under that icon and associated with that media mood. Alternatively, display screen 500 may present all of the suggested media items within the selected media type in one playlist without icons, so that the user may direct playback circuitry 108 to play a media item by selecting the media item on display screen 500.

In some embodiments, for a given media type, the list of media items categorized by associated media moods may include more media moods than can appear on display screen 500 simultaneously. Display screen 500 may present any suitable icon, such as More icon 567, to allow a user to navigate to a continued list of suggested media moods within a given media type. For example, the user may not want to listen to any of the media items associated with icons 561, 563, or 565. The user may touch More icon 567 to be taken to a new display screen (not shown) that may display additional media items with different associated media moods (e.g., sad songs) suggested for playback based upon the user's mood. Alternatively, the user may touch or click display screen 500 to scroll through the list of suggested media moods so that all of the media mood categories may be seen without navigating to an additional display screen.

In some embodiments, the user may wish to listen to all of the suggested media items for a selected media type, regardless of the media mood category. Display screen 500 may present any suitable icon, such as Play All icon 569, to allow a user to listen to each media item within a given media type. For example, if a user selects Play All icon 569 on display screen 500, playback circuitry 108 may play all of the songs included within the media type represented by Suggested Music icon 462, regardless of their associated media mood. Playback circuitry 108 may play all of the songs in any suitable manner (e.g., sequentially, categorically by media mood, or chronologically based upon run time of the media item).

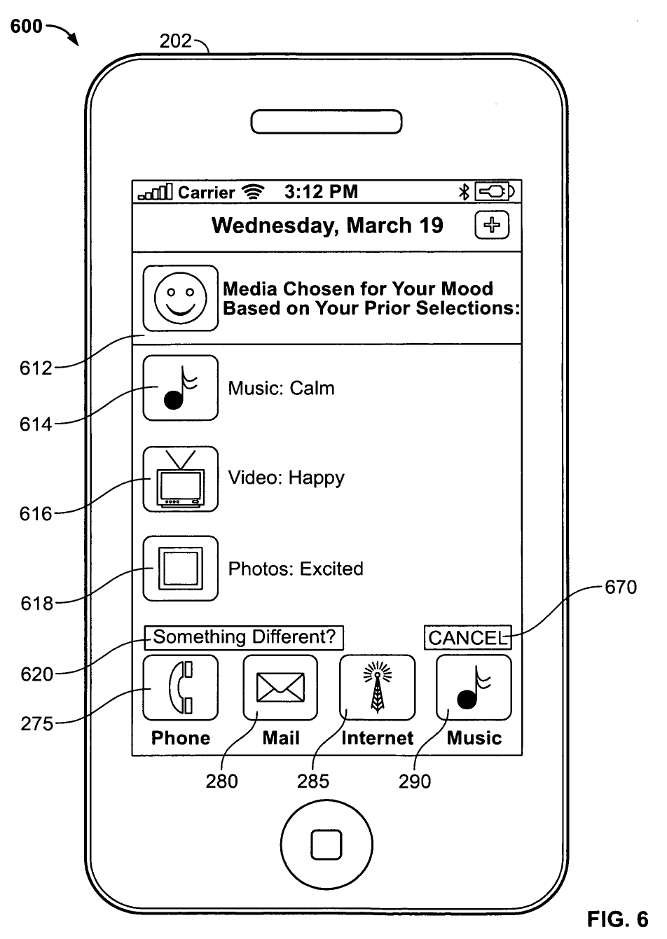

In some embodiments, electronic device 202 may determine that the user's mood is the same as or similar to a previous mood experienced by the user when using electronic device 202. Electronic device 202 may suggest media based upon the user's prior media selections during the user's previous similar mood using any suitable approach. FIG. 6 is a schematic view of an illustrative display screen for viewing suggested media types with associated media moods based upon a user's past media selections in accordance with some embodiments of the invention. Display screen 600, which may be the same as and may include some or all of the features or display screen 200, may be displayed once electronic device 202 has determined that the user's current mood, as obtained at display screen 200, matches a previous mood of the user that electronic device 202 may have stored. Display screen 600 may present a message to the user indicating that electronic device 202 has assembled suggested media based on the user's prior media selections for the same mood, such as message 61, “Media Chosen for Your Mood Based on Your Prior Selections.”

Electronic device 202 may organize the presentation of the suggested media based upon the user's prior selections using any suitable approach. For example, display screen 600 may present an icon representing each suggested media type and its associated suggested media mood or media moods. Such icons may include, for example, Preferred Music icon 614, Preferred Videos icon 616, and Preferred Photos icon 618. A user may select Preferred Music icon 614 to review a playlist of song items or other audio media items with the associated media mood or media moods that electronic device 202 assembled based upon the user's prior media selections during a previously similar mood. Display screen 600 may also present a message or other information to the user, such as the message “Music: Calm” to indicate to the user that the suggested media was assembled based upon the user's prior selection of songs with an associated calm mood during the user's previous similar mood.

For example, the user may currently be relaxed and may have used electronic device 202 in the past when the user was also relaxed. In the past, electronic device 202 may have suggested music items categorized as “calm” to the user as part of a larger list of suggestions containing other media types and other media moods, and the user may have selected one or more of the calm music items. Electronic device 202 may have stored the user's detected mood and the user's choice of calm music item(s) in the memory of control circuitry 110 (FIG. 1). Upon determining that the user's current mood matches a previously stored mood, electronic device 202 may retrieve a record of the stored media items and offer the user the same media items with the same associated media mood that the user may have selected during the previous mood. In some embodiments, electronic device 202 may download from a host system new media items that still may be similar in media mood (e.g., calm songs) to the media items chosen previously by the user during the previous mood.

In some embodiments, electronic device 202 may suggest only one media type in response to determining that the user only selected one media type or one media item within a given media type during a prior similar mood. Alternatively, electronic device 202 may suggest additional media types with associated media moods that may not be based upon the user's prior selections, but may still correspond to the user's current mood. For example, while the user may have chosen “calm” music items in the past during the previous relaxed mood, the user may never have chosen any video items during the previous relaxed mood. Thus, Preferred Music icon 614 may appear on display screen 600 with the message “Music: Calm” while Suggested Videos icon 464 (FIG. 4) may appear on display screen 600 with the message “Try these videos and movies!” (not shown) because electronic device 202 may be suggesting a new, additional media type with one or more associated media moods based upon the user's current mood.

The order in which icons 614, 616, and 618 appear on display screen 600 may be established using any suitable approach. For example, icons 614, 616, and 618 may appear in an order based upon the relative preference that the user may have exhibited for each media type and associated media mood during a prior similar mood. For example, on display screen 600, Preferred Music icon 614 may appear above the other suggested media types because the user may have selected calm music items more often than happy video items and/or excited photographic items when the user experienced a prior mood.

In some embodiments, despite a user's prior selections of certain media types with one or more associated media moods, the user may wish to select a media type or a media mood other than what is suggested by electronic device 202. Display screen 600 may present any suitable option, such as Other Media option 620 with any suitable legend, such as the legend “Something Different?,” to allow the user to search for a media type or a media mood other than what has been suggested by electronic device 202 based on the user's prior similar mood. If the user selects Other Media option 620, the user may access any suitable media types and/or media moods stored in electronic device 202, or the user may access the media types and media moods available for download from a host system. If the user selects Other Media option 620, electronic device 202 may store the user's choice not to select any of the suggested media items in the memory of control circuitry 110 (FIG. 1) and may store the user's alternative choice of media types and/or media moods for playback, if any. In some embodiments, display screen 600 may include a Cancel option 670 which may return the user to another screen on electronic device 202 not related to the suggested media (e.g., display screen 200).

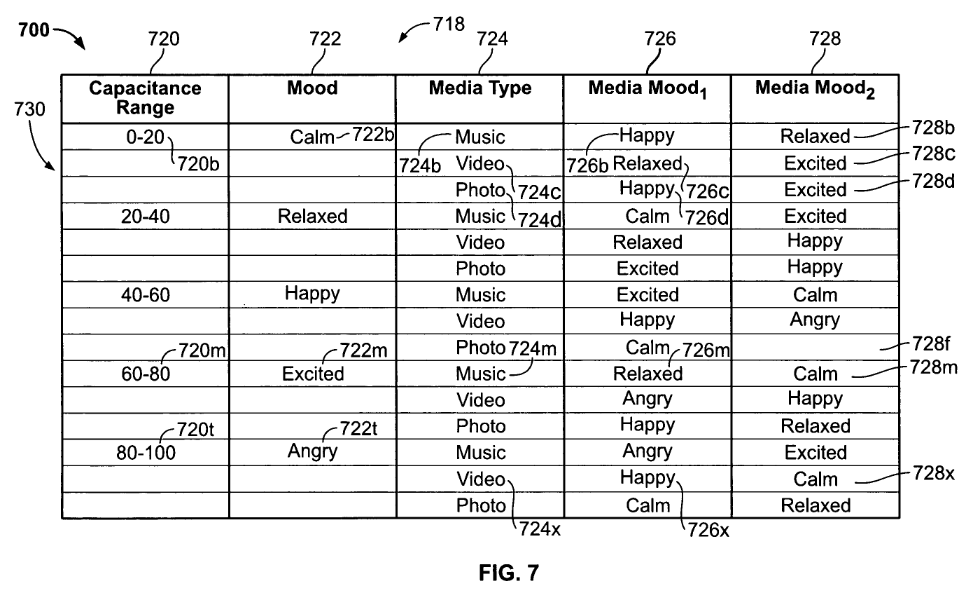

Electronic device 202 may store information regarding media types and media moods to be suggested after detecting a user's mood using any suitable data structure. FIG. 7 is a schematic view of an illustrative data structure for storing information related to media types and media moods associated with a particular user mood in accordance with some embodiments of the invention. Data structure 700 may include rows 730, each of which may be associated with a unique capacitance range, and columns 718 of information relating to suggested media types and one or more suggested media moods associated with each media type for each capacitance range. Data structure 700 may be populated with information about each capacitance range and suggested media types and media moods using any suitable approach. Data structure 700 may be populated with standard settings regarding capacitance ranges, moods corresponding to the capacitance ranges, and suggested media types and media moods to accompany a given mood. Alternatively, the manufacturer may populate data structure 700 with unique choices as to capacitance ranges, moods, media types and media moods. Alternatively, a user of electronic device 202 may insert or alter information stored within data structure 700.

Each capacitance range, representing a number of possible capacitance values that may be obtained from a user (e.g., when a user touches display screen 200, FIG. 2) and that may be used to correlate an associated mood with the range, may be stored in column 720. The capacitance value may be measured and stored in terms of any suitable unit, such as a Farad. For example, element 720b may contain a capacitance range of “0-20,” element 720m may contain a capacitance range of “60-80,” and element 720t may contain a capacitance range of “800-100.” In some embodiments, data structure 700 may limit the maximum number of capacitance ranges that electronic device 202 can store. In some embodiments, the capacitance ranges may overlap in value.

The mood associated with each capacitance range may be stored in column 722. Any suitable number and variety of moods may be stored in column 722, and each capacitance range may correspond to a mood. For example, element 722b may store the mood “calm” associated with the capacitance range “0-20” stored in element 720b. Element 722m may store the mood “excited” associated with the capacitance range “60-80” stored in element 720m, and element 722t may store the mood “angry” associated with the capacitance range “80-100” stored in element 720t.

Electronic device 202 may offer to the user any suitable number of media types corresponding to a given mood 722 associated with a particular capacitance range 720. The media types offered by electronic device 202 may include any suitable media, including sound or audio files, videos, movies, photographs, or any combination therein, capable of being played back by playback circuitry 108 (FIG. 1). In some embodiments, the media types offered to the user may include all of the media types (not shown) capable of being played back by playback circuitry 108. The media types offered to the user may be stored in column 724 and may vary from one corresponding mood 722 to another corresponding mood 722. For example, the user may be offered a variety of music (element 724b), video (element 724c), and photos (element 724d) for a “calm” mood as classified in element 722b. If the user is experiencing another mood, electronic device 202 may offer all of those media type choices, or may offer any other suitable combination of one or more of those media type choices combined with other media types (not shown). For example, electronic device 202 may only suggest to a user experiencing an “excited” mood (as classified in element 722m using capacitance range 720m) one media type, such as music (element 724m). Alternatively, electronic device 202 may suggest to a user experiencing an “angry” mood (as classified in element 722t using capacitance range 720t) one or more videos (element 724x) as the media type. Electronic device 202 may suggest any suitable number of media types to a user, even if electronic device 202 may have more media type suggestions stored within column 724 than electronic device 202 may suggest to the user.

In some embodiments, electronic device 202 may associate any suitable number of media moods, such as those media moods stored in media mood₁ column 726 and media mood₂ column 728, with each media type suggested to a user. For example, if a user is experiencing a “calm” mood, as shown in element 722b, electronic device 202 may suggest music media type 724b, video media type 724c, and photo media type 724d to the user. Within the music media type 724b suggestions, electronic device 202 may suggest happy music, as shown in element 726b, and/or relaxed music, as shown in element 728b. Electronic device 202 also may suggest relaxed videos 726c, excited videos 728c, happy photos 726d, and/or excited photos 728d. In some embodiments, the number of media moods associated with a given media type may include all of the media moods (not shown) capable of being associated with the media type. The decision of which media moods to associate with each media type may be made by an external source (e.g., the manufacturer of electronic device 202, the user, the distributor of the media item within each media type, or a host system from which the media may have been downloaded) or by an internal source (e.g., by control circuitry 110 analyzing metadata associated with each media item). In some embodiments, the media mood offered to the user may match the user's current mood. Alternatively, the media mood may be offered to counteract the user's current mood.

In some embodiments, for a given media type, electronic device 202 may suggest to the user a media type with less than all available associated media moods. For example, if a user is experiencing an “excited” mood as shown in element 722m, then electronic device 202 may suggest relaxed music to the user for listening, as shown in element 726m. In some embodiments, electronic device 202 may not suggest all of the media moods associated with a given media type (e.g., electronic device 202 may not suggest calm music, as stored in element 728m) despite electronic device 202 having information stored in data structure 700 regarding suggested music for the user's current mood. In some embodiments, data structure 700 may lack information regarding a suggested media mood associated with a particular media type for a user's current mood. For example, element 728f is left blank, or has a zero value (not shown) within data structure 700 to indicate the lack of media mood associated with a particular media type.

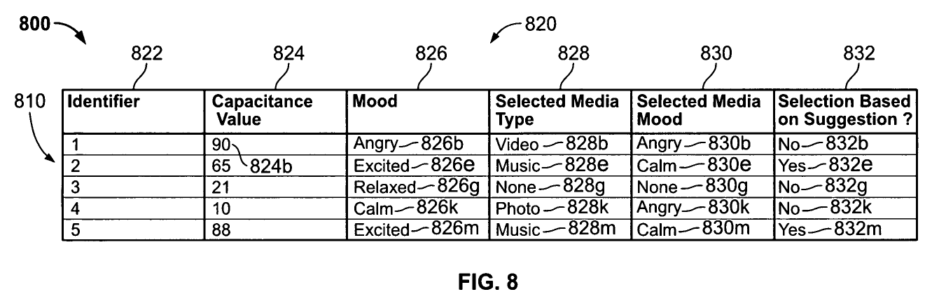

Electronic device 202 may store information regarding the user's moods and the user's media selections during each of those moods using any suitable data structure. FIG. 8 is a schematic view of an illustrative data structure for storing information related to a user's media selections associated with a particular mood in accordance with some embodiments of the invention. Data structure 800 may include rows 810 of individual mood events, and columns 820 of information relating to selected media items for each mood event. Each mood event may be uniquely labeled by an identifier (e.g., a number or character string) stored in column 822. In some embodiments, data structure 800 may limit the maximum number of mood events that electronic device 202 can store. For example, data structure 800 may limit the number of rows 810 available.

The capacitance value obtained and the mood determined for each mood event may be stored in columns 824 and 826, respectively. The capacitance value in column 824 may include any value or range of values recognized as a possible capacitance value obtained from a user of display screen 200 (FIG. 2). Using the capacitance values stored in column 824, electronic device 202 may consult data structure 700 (FIG. 7) to determine the current mood of the user and assign a mood in column 826. Electronic device 202 may compare the capacitance value stored in column 824 against the stored capacitance ranges in column 720 and may assign a mood in column 826 that matches the corresponding mood in column 722. For example, an “angry” mood is stored in element 826b because the capacitance value stored in element 824b falls within capacitance range 720t corresponding to an “angry” mood, as shown in element 722t.

Electronic device 202 may store the user's selection, if any, of media type and associated media mood in columns 828 and 830, respectively. In some embodiments, data structure 800 may consolidate columns 828 and 830 into one column to store data related to the media type and media mood selected by the user. While only one selected media type and one selected media mood is shown in columns 828 and 830, respectively, it is to be understood that data structure 800 may contain any suitable number of media type selections by a user for a given mood event and any suitable number of media mood selections associated with the one or more media type selections.

The data stored in column 828 may include any data suitable to identify the media type selected by the user (e.g., “video” as shown in element 828b, “music” in elements 828e and 828m, “photo” in element 828k, and “none” in element 828g). The data stored in column 830 may include any data suitable to identify the media mood associated with the media type selected by the user in choosing one or more media items. For example, the user may have chosen an angry video during an angry mood, as shown in elements 826b, 828b, and 830b, or the user may have chosen an angry photo during a calm mood, as shown in elements 826k, 828k, and 830k. Alternatively, the user may have selected calm music during an excited mood, as shown in elements 826e, 828e, and 830e. The data stored in columns 828 and 830 may include a “zero” value or “none” value if the user does not select any media. For example, as shown with element 826g, the user may be relaxed. In response, electronic device 202 may suggest any suitable media, such as calm and excited music, relaxed and happy video, and excited and happy photos, as shown in FIG. 7. The user may not select any suggested media types or associated media moods, as shown in elements 828g and 830g. For example, the user may use display screen 200 for a purpose other than having suggested media presented (e.g., the user may want to browse the Internet using Internet option 285 (FIG. 2)).

Electronic device 202 may store the user's decision of whether to select at least one of the suggested media items in column 832. The data stored in column 832 may include a Boolean (e.g., yes/no). For example, the user may not select a suggested media type with an associated media mood because the user may not have selected any media, as shown in element 832g, or the user may have selected media with a media mood different from what data structure 700 may suggest offering to the user, as shown in elements 832b and 832k. Alternatively, the user may have selected at least one suggested media type with an associated media mood, as shown in elements 832e and 832m. In some embodiments, data structure 800 may include any suitable number of columns to store additional information about the suggested media, such as the number of media types and the number of associated media moods suggested, the number of media items offered within each media mood, and any other suitable information. For simplicity, data structure 800 is shown with only column 832 to indicate whether the user selected any one of the media items that may have been suggested by electronic device 202.

When the user generates a new mood event by touching display screen 200, electronic device 202 may add a new row to data structure 800. When a capacitance value has been stored for a certain time period (e.g., seven days), electronic device 202 may keep the row 810 in data structure 800 that is associated with the capacitance value or may delete the row 810 associated with the capacitance value.

In some embodiments, the data stored in data structure 800 may illustrate the capability of electronic device 202 to learn from the user's media selections during the user's previous moods to suggest media that the user may be more likely to select during a similar future mood. For example, electronic device 202 may have determined that the user was in a angry mood, as shown in element 826b. Electronic device 202 may consult data structure 700 for media suggestions to offer to the user, such as video with associated happy and calm moods, as shown by elements 724x, 726x, and 728x. The user may select a video media type, as shown by element 828b, but the user may select a video with an associated angry mood, as shown by element 830b. Electronic device 202 may store in element 832b that the user did not select a happy video or a calm video and may use that information to alter data structure 700 to reflect the user's media preferences during a given mood.

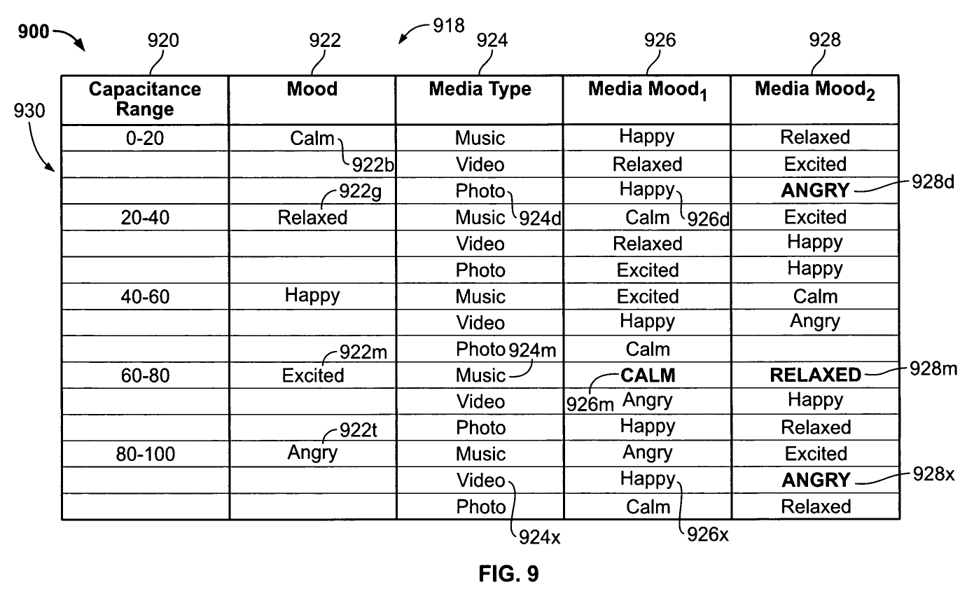

Electronic device 202 may store information regarding the user's past media selections for use in suggesting similar media to a user during a similar future mood using any suitable data structure. FIG. 9 is a schematic view of an illustrative data structure for storing information reflecting a user's prior media selections associated with a particular mood in accordance with some embodiments of the invention. Data structure 900 may include rows 930, each of which may be associated with a unique capacitance range, and columns 918 of information relating to suggested media types and one or more media moods associated with a given media type for each capacitance range. Each capacitance range may be stored in column 920. The mood associated with each capacitance range may be stored in column 922. In some embodiments, column 920 and column 922 may be the same as column 720 and column 722 (FIG. 7). The suggested media types and associated media moods, that may be based upon the user's previous selections in addition to the default suggestions of data structure 700, may be stored in columns 924, 926 and 928. In some embodiments, data structure 900 may have the same number of rows 930 and columns 918 as data structure 700. In some embodiments, data structure 900 may store any suitable number of media types in column 924, including all media types available for playback (not shown) by playback circuitry 108. Data structure 900 may also include any suitable additional columns beyond columns 926 and 928 (not shown) to store any suitable number of additional media moods capable of being associated with a given media type.

Data structure 900 may be populated with information regarding suggested media types and associated media moods that may differ from the information stored in data structure 700 using any suitable approach. For example, data structure 900 may contain a counter (not shown) that may store the number of times that a media mood associated with a particular media type is chosen by a user during a given mood. Thus, each media mood within each media type may be associated with a number. If a particular media mood associated with a particular media type is chosen by a user during a particular mood with a greater frequency than another media mood for the same media type, then data structure 900 may alter the information stored in the media mood columns such that the more frequently chosen media mood may be suggested to the user before the less frequently chosen media mood.

For example, data structure 900 may contain data that directs electronic device 202 to present to a user in a calm mood at least one happy photo, as shown in elements 924d and 926d, and/or at least one angry photo, as shown in elements 924d and 928d. The media mood stored in element 928d may differ from the media mood stored in element 728d, thus causing electronic device 202 to suggest happy and/or angry photos instead of happy photos and/or excited photos (as shown in elements 724d, 726d, and 728d). Data structure 900 may store an “angry” value in element 928d, instead of an “excited” value as shown in element 728d, because the user may select angry photos more frequently than excited photos when the user is in a “calm” mood. After the user selected an angry photo to view, as stored in elements 826k, 828k, and 830k of data structure 800 (FIG. 8), the counter may have incrementally updated the number associated with the “angry” media mood such that the number associated with the “angry” media mood may exceed the number associated with the “excited” media mood, and element 928d may store an “angry” value instead of an “excited” value. The “excited” value may be stored in another media mood column (not shown) to indicate that it may still be associated with photographs to be suggested to the user during a future calm mood, but it may be suggested after angry photographs are first suggested.

Similarly, the user may have selected an angry video to view during a recent angry mood, as shown in elements 826b, 828b, and 830b. The selection of the “angry” media mood associated with the video media type may cause the counter associated with the “angry” media mood to be incrementally updated. The update may make the number of times that the “angry” media mood has been selected greater than the number of times that the “calm” media mood may have been selected in association with a video media type during a user's angry mood. Thus, element 928x may store an “angry” value rather than a “calm” value as shown in element 728x to reflect that the user more often prefers suggested angry videos during an angry mood than suggested calm videos. The “calm” value may be stored in another media mood column (not shown) to indicate that it may still be associated with videos to be suggested to the user during a future angry mood, but it may be suggested after angry videos are first suggested.

In some embodiments, data structure 900 may not alter the stored media types and/or associated media moods if the user does not select any media during a particular mood. For example, the user may have been in a “relaxed” mood, as shown in element 826g, and may not have selected any media to play back, as shown in elements 828g and 830g. Data structure 900 may not alter the order of the suggested media moods in any of the media mood columns (e.g., columns 926 and 928) because the counters associated with each media mood may not be altered if no media mood is selected. Thus, columns 924, 926, and 928 may continue to match columns 724, 726, and 728 for a given relaxed mood.

In some embodiments, data structure 900 may alter the order of suggested media moods if the user consistently selects a particular media mood associated with a media type during a given mood. For example, the user may have experienced an “excited” mood more than once, as shown in element 826e and element 826m. In each instance, the user may have selected music (as shown in elements 828e and 828m) with an associated calm media mood (as shown in elements 830e and 830m) for playback. Data structure 700 may have stored in element 726m that music with a relaxed media mood should be offered to the user first, followed by music with an associated calm media mood (as shown in element 728m). If the user selects calm music during a relaxed mood more frequently than relaxed music, then the counter associated with the calm media mood may be updated to reflect the user's selections and the calm media mood counter may have a greater value than the counter associated with the relaxed media mood. As a result, data structure 900 may reverse elements 926m and 928m to reflect that music with a calm media mood may be first suggested to the user during a future “excited” mood, followed by music with an associated relaxed media mood.

In some embodiments, data structure 900 may alter the order of suggested media types if the user consistently selects a particular media type during a given mood. For example, if the user experiences a calm mood on repeated occasions and if the user selects the video media type in element 724c more frequently than the music media type in element 724b, then a counter (not shown) associated with the video media type may have a greater value than a counter associated with the music media type. The media types offered by electronic device 202 to a user during a calm mood may be reordered such that they are suggested in order of decreasing counter value. Thus, if the video media type has a greater counter value than the music media type counter value, then the video media type may be suggested to a user during a future calm mood before the music media type.

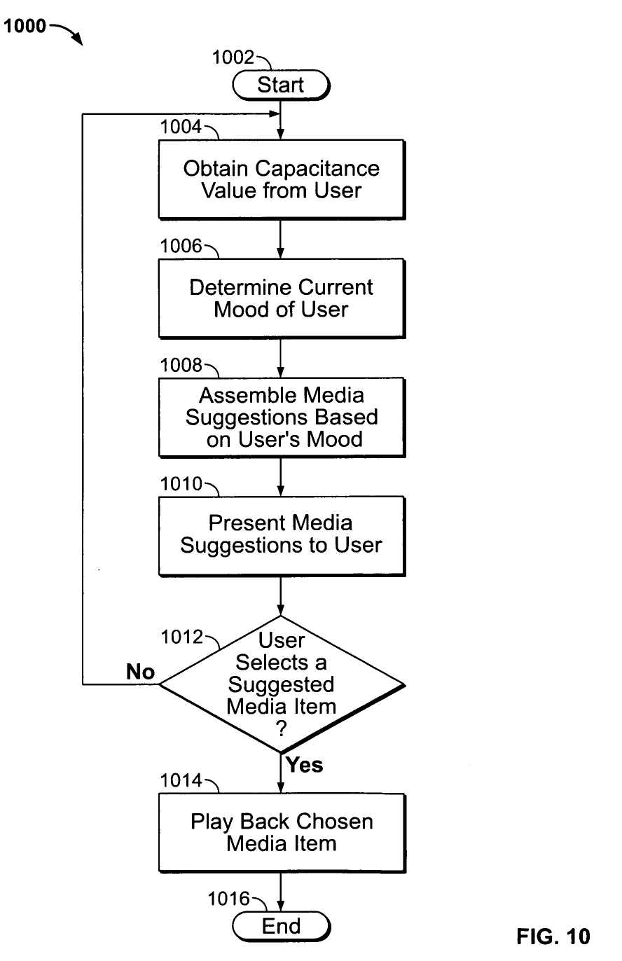

Electronic device 202 may determine the mood of a user of an electronic device from the capacitance value obtained from the user. The electronic device may then suggest media for playback to suit the user's mood. FIG. 10 is a flowchart of an illustrative process for playing a selected media item suggested by an electronic device based upon a user's mood in accordance with some embodiments of the invention. Process 1000 may begin at step 1002. At step 1004, an electronic device may obtain a capacitance value from the user when the user uses the electronic device (e.g., capacitance sensor 107 may obtain a capacitance value when the user touches display screen 200 in FIG. 2). Process 1000 may then advance to step 1006, where the electronic device may analyze the capacitance value obtained from the user (e.g., using control circuitry 110 in FIG. 1). The electronic device may determine the user's current mood by comparing the obtained capacitance value against the user's own baseline capacitance values, as stored in the electronic device, or against a common set of capacitance ranges associated with particular moods as observed in a sample of individual. Process 1000 may then advance to step 1008.

At step 1008, the electronic device may use the determination of the user's mood to assemble media suggestions based upon the determined mood (e.g., using data structure 700 and/or data structure 900). At step 1010, the electronic device may present the media suggestions to the user for review and selection. At step 1012, the user may decide whether to select one or more of the media suggestions for playback. If the user does not select of the media suggestions to play back, then process 1000 may return to step 1004 to await the next capacitance value obtained from the user. If the user selects one or more of the media suggestions to play back, then process 1000 may advance to step 1014, where the electronic device may play back the chosen media item(s) (e.g., using playback circuitry 108 of FIG. 1). In some embodiments, if a user selects more than one media item for play back, the electronic device may play back the selected media items sequentially, or may play back some or all of the selected media items simultaneously. For example, the electronic device may simultaneously play back music and display photographs (e.g., selected by the user or automatically selected by the electronic device). Process 1000 may then advance to step 1016 and end.

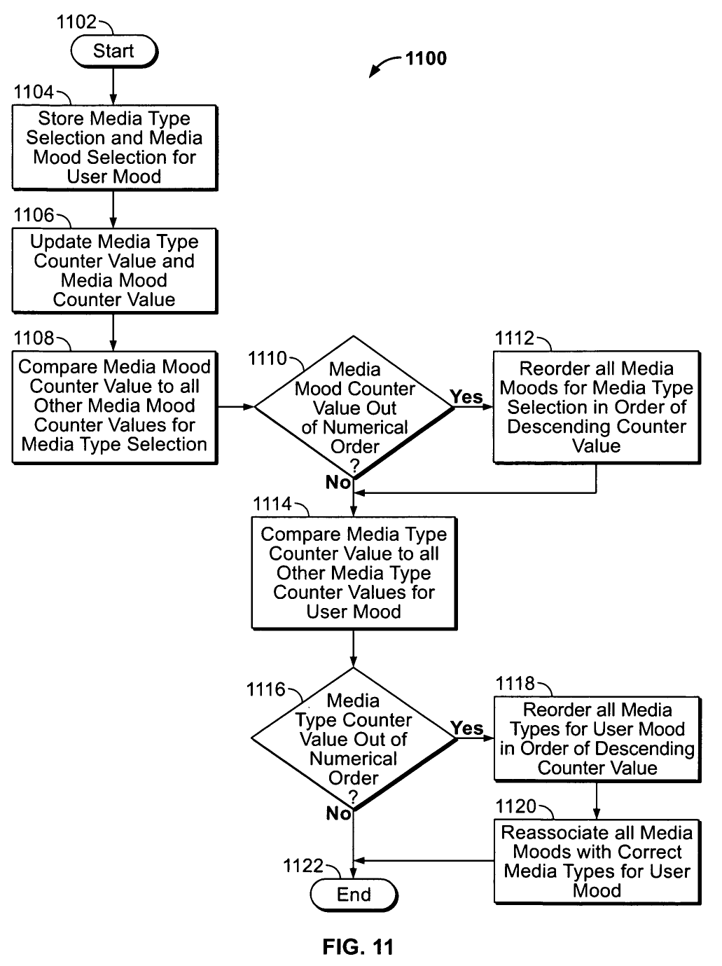

Electronic device 202 may use stored information relating to a user's prior media suggestions to make future media suggestions to the user using any suitable method. FIG. 11 is a flowchart of an illustrative process for updating media suggestions media based upon a user's prior media selections in accordance with some embodiments of the invention. Process 1100 may begin at step 1102. At step 1104, the electronic device may store in any suitable data structure a user's selection of a media type and an associated media mood for a given user mood (e.g., using data structure 800, FIG. 8). While only one media type selection with one associated media mood is shown in FIG. 11, it is to be understood that during a given user mood, the user may select any suitable number of media types with any suitable number of associated media moods.

At step 1106, the data structure may update the value of a counter associated with the selected media type and the value of a counter associated with the selected media mood. All of the media types and all of the media moods in the data structure may have an independent counter to store the number of times that a given media type and/or a given media mood may be selected by a user. Process 1100 may advance to step 1108, where the counter value of the selected media mood may be compared to the counter values of all of the other media moods associated with the selected media type. For example, in data structure 700, the counter value associated with relaxed media mood 726m may be compared to the counter values associated with calm media mood 728m.

Process 1100 may advance to step 1110, where the comparison of step 1108 may be analyzed. If the counter value of the selected media mood renders all of the media mood counter values out of numerical order for the selected media type, then process 1100 may advance to step 1112, where all of the media moods for the selected media type may be reordered in order of descending counter value. For example, in data structure 900, the calm media mood shown in element 926m may have a higher counter value than the relaxed media mood shown in element 928m, and the order of the two media moods may be reordered from what is stored in data structure elements 726m and 728m. Process 1100 may advance to step 1114. At step 1110, if the counter value of the selected media mood does not render all of the media mood counter values out of numerical order for the selected media type, then process 1112 may advance to step 1114.

At step 1114, the counter value of the selected media type may be compared to the counter values of all of the other media types associated with the user mood. For example, in data structure 700, the counter value associated with music media item 724m may be compared to the counter values associated with the other media types (e.g., video and photo) for the user mood (e.g., excited).

Process 1100 may advance to step 1116, where the comparison of step 1114 may be analyzed. If the counter value of the selected media type renders all of the media type counter values out of numerical order for the user mood, then process 1100 may advance to step 1118, where all of the media types for the user mood may be reordered in order of descending counter value. For example, in data structure 900, the video media type shown in element 924x may be reordered (not shown) with respect to the other media types if the counter value of the video media type places the video media type out of numerical order with the music media type and photo video type counters. Process 1100 may advance to step 1120, where all of the media moods may be reassociated with the correct media type for the user mood. Process 1100 may then advance to step 1122 and end.

At step 1116, if the counter value of the selected media type does not render all of the media type counter values out of numerical order for the user mood, then process 1100 may advance to step 1122 and end.

While there have been described systems and methods for creating a variety of playlists in an electronic device based upon a user's mood, it is to be understood that many changes may be made therein without departing from the spirit and scope of the invention. It will also be understood that various directional and orientational terms such as “up” and “down,” “left” and “right,” “top” and “bottom,” “side” and “edge” and “corner,” “height” and “width” and “depth,” “horizontal” and “vertical,” and the like are used herein only for convenience, and that no fixed or absolute directional or orientational limitations are intended by the use of these words. For example, the positioning of a display screen within an electronic device and various icons contained within a display screen may have any desired orientation. If reoriented, different directional or orientational terms may need to be used in their description, but that will not alter their fundamental nature as within the scope of the invention. Those skilled in the art will appreciate that the invention can be practiced by other than the described embodiments, which are presented for purposes of illustration rather than of limitation, and the invention is limited only by the claims which follow.

What is claimed is:

1. An electronic device for suggesting media for playback based upon a user's mood, the electronic device comprising control circuitry and a display, the control circuitry operative to:
detect a capacitance value from the user;
determine the user's mood using the detected capacitance value;
identify at least one media item available for playback associated with the detected user's mood; and
direct the display to present the at least one identified media item to the user.

2. The electronic device of claim 1, further comprising a capacitance sensor operative to detect the capacitance value from the user.

3. The electronic device of claim 2, wherein the control circuitry is further operative to disable the capacitance sensor.

4. The electronic device of claim 1, further comprising playback circuitry, wherein the control circuitry is operative to direct the playback circuitry to play back the at least one identified media item.

5. The electronic device of claim 1, wherein the at least one identified media item is at least one of music, video, images, photographs, books, websites, and magazines.

6. The electronic device of claim 1, wherein the control circuitry is operative to identify at least one other media item available from a remote host system.

7. The electronic device of claim 1, wherein the at least one identified media item is at least one of a mood type similar to the user's mood, opposite to the user's mood, and different from the user's mood.

8. An electronic device for suggesting media for playback based upon a user's past moods, the electronic device comprising control circuitry and a display, the control circuitry operative to:
detect a capacitance value from the user;
determine the user's mood using the detected capacitance value;
compare the user's current mood to information stored in the control circuitry related to the user's past moods;
identify at least one past media item selection based upon the information stored in the control circuitry;
identify at least one current media item available for playback using the user's past moods; and
direct the display to present the at least one current media item to the user.

9. The electronic device of claim 8, wherein the control circuitry is operative to assemble a media playlist from the at least one current media item.

10. The electronic device of claim 9, wherein the control circuitry is operative to assemble the media playlist using at least one other media item available from a remote host system.

11. The electronic device of claim 8, further comprising playback circuitry, wherein the control circuitry directs the playback circuitry to play back the at least one current media item.

12. The electronic device of claim 8, wherein the at least one current media item is at least one of music, video, images, photographs, books, websites, and magazines.

13. The electronic device of claim 8, wherein the control circuitry is further operative to disable detection of a capacitance value in the user.

14. The electronic device of claim 8, wherein the control circuitry further comprises a capacitance sensor for detecting the capacitance value from the user.

15. The electronic device of claim 8, wherein the at least one current media item is at least one of a mood type similar to the user's past moods, opposite to the user's past moods, and different from the user's past moods.

16. A method for suggesting a media playlist for playback on an electronic device based upon a user's mood, the method comprising:
detecting a capacitance value from the user;
determining the user's mood using the detected capacitance value;
identifying at least one media item available for playback using the user's mood;
assembling the media playlist from the at least one identified media item; and
playing back the at least one identified media item from the media playlist.

17. The method of claim 16, further comprising displaying the media playlist.

18. The method of claim 16, further comprising:
receiving with a sensor the capacitance value from the user; and
transmitting the capacitance value to the electronic device.

19. The method of claim 16, further comprising assembling the media playlist using at least one other media item available from a remote host system.

20. The method of claim 16, wherein the at least one identified media item is at least one of music, video, images, photographs, books, websites, and magazines.

21. The method of claim 16, wherein the at least one identified media item is at least one of a mood type similar to the user's mood, opposite to the user's mood, and different from the user's mood.

22. A system for suggesting a media playlist for playback based upon a user's mood, the system comprising:
an electronic device;
control circuitry within the electronic device for detecting a capacitance value from the user, determining the user's mood, identifying at least one media item available for playback, and assembling the media playlist from the at least one identified media item; and
a display within the electronic device for presenting the media playlist to the user.

23. The system of claim 22, further comprising playback circuitry within the electronic device to play the at least one identified media item.

24. The system of claim 22, further comprising a sensor within the control circuitry for detecting the capacitance value from the user.

25. The system of claim 22, wherein the control circuitry is operative to assemble the media playlist using at least one other media item available from a remote host system.

26. The system of claim 22, wherein the at least one identified media item is at least one of music, video, images, photographs, books, websites, and magazines.

27. The system of claim 22, wherein the at least one identified media item is at least one of a mood type similar to the user's mood, opposite to the user's mood, and different from the user's mood.
